(19) United States
(12) Patent Application Publication
(10) Pub. No.: US 2026/0252982 A1
(43) Pub. Date: Aug. 27, 2026

(54) MULTI-ROBOT CONTROL APPARATUS AND METHOD FOR ALLOCATING TASKS THEREOF

(71) Applicants: Hyundai Motor Company, Seoul (KR); Kia Corporation, Seoul (KR); ROAI Co., Ltd., Seoul (KR)

(72) Inventors: Youjin Jang, Hwaseong-si (KR); Dae Han Sim, Hwaseong-si (KR); Sukeui Hong, Hwaseong-si (KR); Seungwoo Hong, Hwaseong-si (KR)

(21) Appl. No.: 19/392,246

(22) Filed: Nov. 18, 2025

(30) Foreign Application Priority Data
Feb. 24, 2025 (KR) 10-2025-0023923

(51) Int. Cl. G06Q 10/0631; G05D 1/698

(52) U.S. Cl. CPC G06Q 10/06311; G05D 1/6987

(57) ABSTRACT

In an embodiment, a plurality of task points may be allocated to a plurality of robots by a processor of a multi-robot control apparatus is provided. Corresponding task points may be allocated among the plurality of task points to each of the plurality of robots, if it is determined that the task distribution for the plurality of robots is not optimal, determines redistribution-required task points that need to be redistributed for each of the plurality of robots, and redistributes at least one of the redistribution-required task points to at least one redistribution expected robots matched to the at least one redistribution-required task points.

### CROSS-REFERENCE TO RELATED APPLICATIONS

This application claims the benefit of priority to and the benefit of Korean Patent Application No. 10-2025-0023923 filed with the Korean Intellectual Property Office on Feb. 24, 2025, the entire contents of which are incorporated herein by reference.

### TECHNICAL FIELD

The present disclosure relates to a multi-robot control apparatus and a method for allocating tasks thereof.

### BACKGROUND

A multi-robot system is a system in which a plurality of robots cooperate to perform specific tasks in the same task space. When tasks are performed using the plurality of robots, it is faster and more efficient than performing the tasks using just one robot. In this multi-robot system, the problem of distributing (allocating) tasks to robots and optimizing the task order, that is the multi-robot scheduling problem, must be solved.

The optimization of the task distribution of the robots may be determined based on the number of distributed tasks. At this time, good task distribution means that no specific robot is distributed too much tasks and operates for longer hours than other robots. If tasks are not distributed optimally to robots, the total task time may be longer. Therefore, after tasks are distributed to robots, it is necessary to check whether the tasks are distributed well to the robots and redistribute them if a workload is concentrated on a specific robot.

### SUMMARY

Some embodiments of the present disclosure provide a multi-robot control apparatus and a method for distribution tasks thereof capable of reducing the total task time due to imbalance in task distribution of robots.

According to one embodiment, a method for allocating a plurality of task to a plurality of robots by a processor a processor executes a program stored in memory may be provided. The method includes: allocating corresponding task points among a plurality of task points to each of the plurality of robots; determining redistribution-required task points that need to be redistributed for each of the plurality of robots based on the number of task points allocated to each of the plurality of robots; matching a corresponding redistribution expected robot to each of redistribution-required task points of each of the plurality of robots among the plurality of robots; arranging the plurality of robots in order of number of task points requiring redistribution of each of the plurality of robots; determining redistribution candidate robots belonging to each robot redistribution application ratio among the arranged plurality of robots, according to each of a plurality of robot redistribution application ratios indicating a ratio at which redistribution is performed among the plurality of robots; redistributing a plurality of redistribution-required task points of the redistribution candidate robots to a plurality of redistribution expected robots matched to the plurality of redistribution-required task points among the plurality of robots, in each of the plurality of robot redistribution application ratios; calculating a task distribution degree based on the number of task points of each of the plurality of robots, in each of the plurality of robot redistribution application ratios; determining a first robot redistribution application ratio having the smallest task distribution degree among the task distribution degrees calculated for the plurality of robot redistribution application ratios; redistributing each of the plurality of redistribution-required task points of first redistribution candidate robots corresponding to the first robot redistribution application ratio to the matched redistribution expected robot; and controlling the plurality of robots according to the task points finally distributed to each of the plurality of robots.

The determining redistribution-required task points may include calculating a center point of each of a plurality of clusters including task points distributed to each of the plurality of robots and corresponding to each of the plurality of robots; calculating Euclidean distance between each of the plurality of task points and the center point of each of the plurality of clusters; and determining the redistribution-required task points among the plurality of task points by using the Euclidean distances calculated for each of the plurality of task points to the center point of each of the plurality of clusters.

The determining the redistribution-required task points among the plurality of task points may include comparing a plurality of first Euclidean distances and a second Euclidean distance, for each of the plurality of task points, wherein the plurality of first Euclidean distances which are Euclidean distances between each task point and the center point of each of a plurality of first cluster that do not include the each task point among the plurality of clusters, the second Euclidean distance which is a Euclidean distance between each task point and the center point of a second cluster that includes each task point; and determining a task point having at least one first Euclidean distance shorter than the second Euclidean distance among the plurality of task points as the redistribution-required task point.

The matching may include determining a robot of a cluster corresponding to the shortest Euclidean distance among the Euclidean distances between each redistribution-required task point and the center points of the plurality of first clusters that do not include the each redistribution-required task point among the plurality of clusters as the redistribution expected robot for the each redistribution-required task.

The calculating a center point of each of a plurality of clusters may include generating at least one first cluster by performing density-based clustering on the task points allocated to each robot; and setting the center point of a first cluster including the largest number of task points among the at least one first cluster for each robot as the center point of the cluster corresponding to each robot.

The calculating a task distribution degree may include excluding task points that cannot be redistributed among the plurality of redistribution-required task points of the redistribution candidate robots, from redistribution.

The excluding may include determining redistribution-required task points corresponding to the redistribution candidate robot among the plurality of redistribution-required task points of the redistribution candidate robots as the task points that cannot be redistributed.

The determining redistribution-required task points may include determining the redistribution-required task points for each of the plurality of robots, if the difference between the number of least allocated task points and the number of most allocated task points among task points allocated to each of the plurality of robots is greater than a set threshold value.

According to another embodiment, a multi-robot control apparatus that allocates a plurality of task points in a task space to a plurality of robots may be provided. The multi-robot control apparatus includes a memory configured to stores one or more instructions; and a processor configured to execute one or more instructions, wherein the processor, by executing one or more of the instructions, allocates corresponding task points among the plurality of task points to each of the plurality of robots, determines whether a task distribution for the plurality of robots is optimal based on the number of task points allocated to each of the plurality of robots, if it is determined that the task distribution is not optimal, determines redistribution-required task points that need to be redistributed for each of the plurality of robots by using Euclidean distance between each of the plurality of task points and a center point of each of a plurality of clusters including the task points allocated to each of the plurality of robots, matches a corresponding redistribution expected robot to each of redistribution-required task points of each of the plurality of robots among the plurality of robots, redistributes at least one of the redistribution-required task points of each of the plurality of robots to the corresponding redistribution expected robot, and controls the plurality of robots according to the task points finally distributed to each of the plurality of robots. It will be appreciated the meaning of the term “optimal” may change depending on context, time and resources available to make the determination. A near-optimal distribution determination may be the best-known “optimal” determination in a given circumstance. Thus, as used in the Specification, claims and figures, “optimal” is intended to include substantially optimal, near-optimal, improved, enhanced, etc.

The processor may arrange the plurality of robots in order of number of task points requiring redistribution of each of the plurality of robots, determine redistribution candidate robots belonging to each robot redistribution application ratio among the arranged plurality of robots, according to each of a plurality of robot redistribution application ratios indicating a ratio at which redistribution is performed among the plurality of robots, redistribute a plurality of redistribution-required task points of the redistribution candidate robots to a plurality of redistribution expected robots matched to the plurality of redistribution-required task points among the plurality of robots, in each of the plurality of robot redistribution application ratios, calculate a task distribution degree based on the number of task points of each of the plurality of robots, in each of the plurality of robot redistribution application ratios, and redistribute each of the plurality of redistribution-required task points of first redistribution candidate robots corresponding to a first robot redistribution application ratio having the smallest task distribution degree among the task distribution degrees calculated for the plurality of robot redistribution application ratios, to the matched redistribution expected robot.

The processor may determine redistribution-required task points corresponding to the redistribution candidate robots among the plurality of redistribution-required task points of the redistribution candidate robots as task points that cannot be redistributed, and exclude task points that cannot be redistributed among the plurality of redistribution-required task points of the redistribution candidate robots, from redistribution.

The processor may set the plurality of robot redistribution application ratios from top 0% to 100% at a predetermined interval.

The processor may compare a plurality of first Euclidean distances and a second Euclidean distance, for each of the plurality of task points, wherein the plurality of first Euclidean distances which are Euclidean distances between each task point and the center point of each of a plurality of first cluster that do not include the each task point among the plurality of clusters, the second Euclidean distance which is a Euclidean distance between the each task point and the center point of a second cluster that includes the each task point, and determine a task point having at least one first Euclidean distance shorter than the second Euclidean distance among the plurality of task points as the redistribution-required task point.

The processor may determine a robot of a cluster corresponding to the shortest first Euclidean distance among the at least one first Euclidean distance as the redistribution expected robot for the redistribution-required task.

The processor may generate at least one first cluster by performing density-based clustering on the task points allocated to each robot, and set the center point of a first cluster including the largest number of task points among the at least one first cluster for each robot as the center point of the cluster corresponding to each robot.

The processor may determine the redistribution-required task points for each of the plurality of robots, if the difference between the number of least allocated task points and the number of most allocated task points among task points allocated to each of the plurality of robots is greater than a set threshold value.

### BRIEF DESCRIPTION OF THE DRAWINGS

FIG. 1 is a schematic diagram illustrating a multi-robot system according to one embodiment;

FIG. 2 is a drawing showing the multi-robot control apparatus illustrated in FIG. 1;

FIG. 3 is a flowchart illustrating a task allocation method of the multi-robot control apparatus illustrated in FIG. 1;

FIG. 4 is a flowchart illustrating a task redistribution method of the redistribution determiner illustrated in FIG. 3;

FIG. 5 is a flowchart illustrating a method for determining redistribution-required task points and redistribution expected robots according to an embodiment;

FIG. 6 is a diagram showing an example of a method for calculating a center point of a cluster according to an embodiment;

FIG. 7 is a diagram showing an example of the Euclidean distance between a task point and a center point of each of a plurality of clusters according to an embodiment;

FIG. 8 is a flowchart illustrating a method for determining a robot re-distribution application ratio according to an embodiment;

FIG. 9 is a diagram showing a task distribution degree according to the robot redistribution application ratio according to an embodiment; and

FIG. 10 is a drawing showing a multi-robot control apparatus according to another embodiment.

### DETAILED DESCRIPTION OF ILLUSTRATIVE EMBODIMENTS

Hereinafter, embodiments of the present disclosure will be described in detail with reference to the appended drawings so that a person of ordinary skill in the art may easily implement the present disclosure. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

In the flowchart described with reference to the drawings in the present specification, the order of operations may be changed, several operations may be merged, some operations may be divided, and specific operations may not be performed.

Throughout the specification and claims, when a part is referred to “include” a certain element, it means that it may further include other elements rather than exclude other elements, unless specifically indicated otherwise.

Also, expressions written in the singular may be interpreted as singular or plural, unless explicit expressions such as “one” or “singular” are used.

Additionally, terms including an ordinal number, such as first, second, etc., may be used to describe various elements, but the elements are not limited by the terms. The above terms are used only for distinguishing one element from another element. For example, without departing from the scope of the present disclosure, a first element may be referred to as a second element, and similarly, a second element may be referred to as a first element.

Furthermore, throughout the specification and claims, when an element is referred to as being “connected” to another element, it should be understood that it may be directly connected to the other element, but other elements in the middle between the element and another element may exist. On the other hand, when an element is referred to as “directly connected” to another element, it should be understood that no other element exists in the middle.

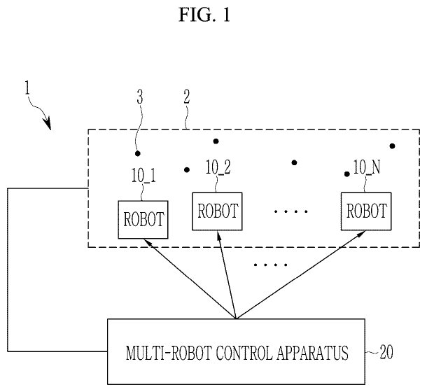

FIG. 1 is a schematic diagram illustrating a multi-robot system according to one embodiment.

Referring to FIG. 1, a multi-robot system 1 is a system in which a plurality of robots 10_1 to 10_N cooperate to perform specific task in the same task space 2. For example, a multi-robot system 1 may simultaneously weld (task) by dividing a plurality of welding points (task points) in a task space 2.

The task space 2 may include a plurality of task points 3, which are positions where a plurality of robots 10_1 to 10_N are to perform task.

The multi-robot system 1 may include a plurality of robots 10_1 to 10_N and a multi-robot control apparatus 20.

The multi-robot control apparatus 20 may allocate (distribute) the plurality of task points 3 in the task space 2 to the plurality of robots 10_1 to 10_N.

In addition, the multi-robot control apparatus 20 determines whether the task distribution is optimal based on the number of task points allocated to each of the plurality of robots 10_1 to 10_N, and if it is determined that the task distribution is not optimal, it determines task points to be redistributed, and may effectively redistribute the task points to be redistribute to the robots capable of tasking.

The multi-robot control apparatus 20 may control the plurality of robots 10_1 to 10_N to efficiently perform tasks at task points distributed to each of the plurality of robots 10_1 to 10_N.

In this way, the multi-robot control apparatus 20 may minimize the difference in task completion time between the plurality of robots 10_1 to 10_N by distributing the task points that are excessively allocated to specific robots, thereby reducing the total task time.

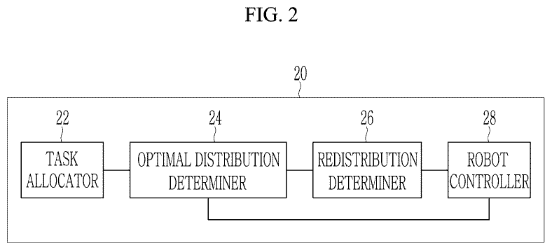

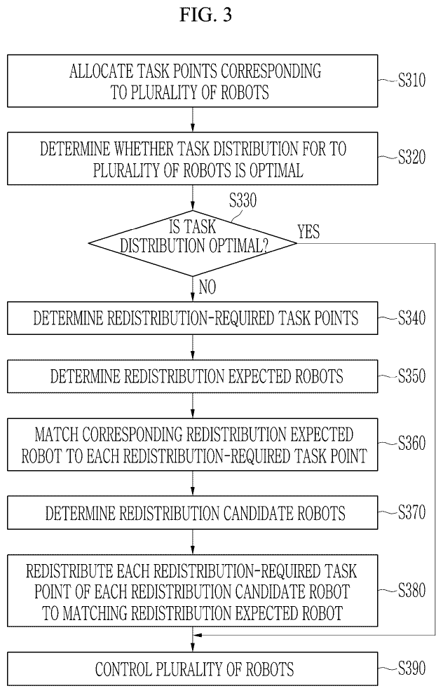

FIG. 2 is a drawing showing the multi-robot control apparatus illustrated in FIG. 1, and FIG. 3 is a flowchart illustrating a task allocation method of the multi-robot control apparatus illustrated in FIG. 1.

Referring to FIG. 2, the multi-robot control apparatus 20 may include a task allocator 22, an optimal distribution determiner 24, a redistribution determiner 26, and a robot controller 28.

Referring to FIGS. 2 and 3 together, the task allocator 22 may allocate (distribute) task points 3 corresponding to the plurality of robots 10_1 to 10_N (S310). The task allocator 22 may allocate task points 3 corresponding to the plurality of robots 10_1 to 10_N using an algorithm such as a K-means algorithm or a genetic algorithm.

The optimal distribution determiner 24 may check the number of task points allocated to each of the plurality of robots 10_1 to 10_N by the task allocator 22, and determine whether the task distribution for the plurality of robots 10_1 to 10_N is optimal based on the number of task points allocated to each of the plurality of robots 10_1 to 10_N (S320). The optimal distribution of tasks among robots 10_1~10_N means that no specific robot is allocated too many tasks, resulting in that specific robot being tasked for longer periods of time than other robots. The optimal distribution of tasks among robots 10_1~10_N means that the plurality of robots 10_1 to 10_N may complete tasks at the same or similar times.

In some embodiments, the optimal distribution determiner 24 arranges the number of task points allocated to each of the plurality of robots 10_1 to 10_N, and if the difference between the smallest number of task points and the largest number of task points among the numbers of task points allocated to each of the plurality of robots 10_1 to 10_N is less than or equal to a set value, it may be determined that the task distribution to the plurality of robots 10_1 to 10_N is optimal.

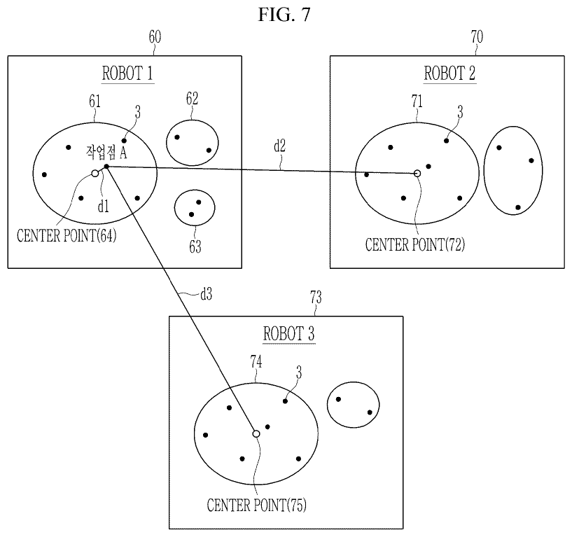

If the optimal distribution determiner 24 determines that the task distribution among the plurality of robots 10_1 to 10_N is not optimal (S330), the redistribution determiner 26 may determine redistribution-required task points that need to be redistributed of each robot 10_1 to 10_N among the task points allocated to each of the plurality of robots 10_1 to 10_N (S340. The task points that need to be redistributed may be task points that are determined to be more efficient to be distributed to other robots than the currently allocated robot based on Euclidean distances, and this will be described in detail with reference to FIG. 7.

The redistribution determiner 26 determines redistribution expected robots to receive the redistribution-required task points of each of the plurality of robots 10_1 to 10_N (S350), and may match a corresponding redistribution expected robot to each redistribution-required task point of each of a plurality of robots 10_1 to 10_N (S360).

The redistribution determiner 26 determines redistribution candidate robots to be redistributed among the plurality of robots 10_1 to 10_N by using the redistribution-required task points of each of the plurality of robots 10_1 to 10_N (S370), and may redistribute each of the redistribution-required task points of the redistribution candidate robots to the matching redistribution expected robot (S380).

After the task points to be redistributed to the expected redistribution robots are redistributed, the robot controller 28 may control the plurality of robots 10_1 to 10_N to efficiently perform tasks at the task points distributed to each of the plurality of robots 10_1 to 10_N (S390).

Meanwhile, if it is determined by the optimal distribution determiner 24 that the task distribution among the plurality of robots 10_1 to 10_N is optimal (S330), the robot controller 28 may control the plurality of robots 10_1 to 10_N to efficiently perform the tasks at the task points distributed to each of the plurality of robots 10_1 to 10_N (S390).

Each of the plurality of robots 10_1 to 10_N may perform tasks at a distributed task points under the control of the robot controller 28.

In some embodiments, after each of the redistribution-required task points of the redistribution candidate robots is redistributed to the matching redistribution expected robot, a process S320 of determining whether the task distribution for the plurality of robots 10_1 to 10_N is optimal may be performed by the optimal distribution determiner 24.

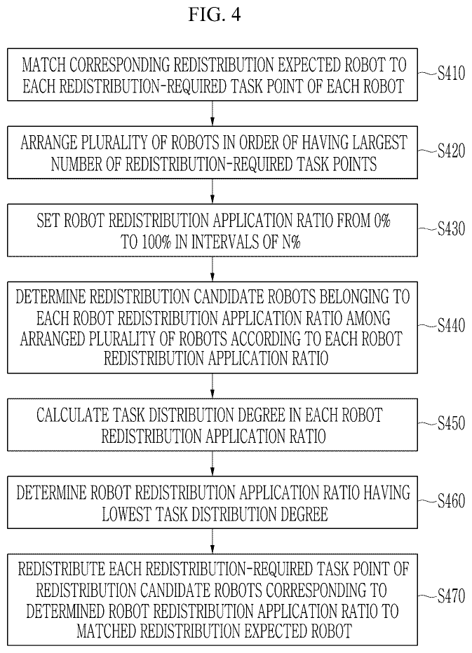

FIG. 4 is a flowchart illustrating a task redistribution method of the redistribution determiner illustrated in FIG. 3.

Referring to FIG. 4, the redistribution determiner 26 determines redistribution-required task points for each of the plurality of robots 10_1 to 10_N among the task points allocated to each of the plurality of robots 10_1 to 10_N, determines redistribution-predicted robots to be distributed the redistribution-required task points for each of the plurality of robots 10_1 to 10_N, and may match a corresponding redistribution expected robot to each redistribution-required task point of each of a plurality of robots 10_1 to 10_N (S410).

The redistribution determiner 26 may arrange the plurality of robots 10_1 to 10_N in order of having the largest number of redistribution-required task points, based on the number of redistribution-required task points of each of the plurality of robots 10_1 to 10_N (S420).

The redistribution determiner 26 may set the robot redistribution application ratio from 0% to 100% in intervals of n % (S430). The robot redistribution application ratio may represent the ratio of robots that may perform redistribution among the plurality of robots 10_1 to 10_N. Here, n may be a positive number. For example, if 100 robots are arranged and n is set to 1%, the robot redistribution application ratio may be set to the top 1%, 2%, 3%, . . . , up to 100%, for a total of 100 robot redistribution application ratios. The top 1% may include the one robot with the most redistribution-requiring task points among 100 robots. The top 2% may include the two robots with the most redistribution-requiring task points among 100 robots.

The redistribution determiner 26 may determine redistribution candidate robots belonging to each robot redistribution application ratio among the arranged plurality of robots 10_1 to 10_N according to each of the plurality of robot redistribution application ratios (S440). The redistribution candidate robots may represent robots that may be redistributed among the arranged plurality of robots 10_1 to 10_N according to the robot redistribution application ratio.

The redistribution determiner 26 redistributes a plurality of redistribution-required task points of redistribution candidate robots belonging to each robot redistribution application ratio to a plurality of redistribution expected robots that are matched to the redistribution candidate robots among the plurality of robots 10_1 to 10_N, and then calculates task distribution degree in each robot redistribution application ratio based on the number of task points of each of the plurality of robots (S450). The task distribution degree may be calculated, by squaring each value obtained by subtracting the average the task points from the task points distributed to each of the plurality of robots 10_1 to 10_N, adding up all N squared values, and then dividing by N, the number of robots. Here, the average of the task points may be the total number of task points divided by N, the number of robots.

The redistribution determiner 26 may determine the robot redistribution application ratio having the lowest task distribution degree among the task distribution degrees calculated for the plurality of robot redistribution application ratios (S460).

The redistribution determiner 26 may redistribute each of the redistribution-required task points of the redistribution candidate robots corresponding to the determined robot redistribution application ratio to the matched redistribution expected robot (S470).

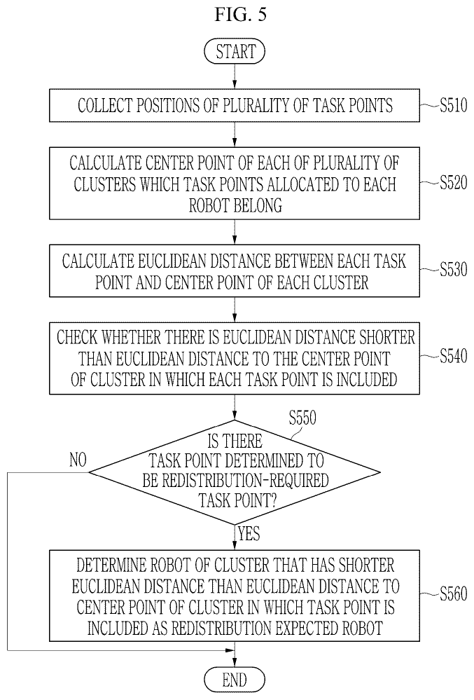

FIG. 5 is a flowchart illustrating a method for determining redistribution-required task points and redistribution expected robots according to an embodiment.

Referring to FIG. 5, the redistribution determiner 26 may collect a position of each of a plurality of task points (S510).

The redistribution determiner 26 calculates a center point of each of the plurality of clusters to which the task points allocated to each of the plurality of robots 10_1 to 10_N by the task allocator 22 belong (S520). The center point of each of the plurality of clusters may be calculated based on the positions of the task points belonging to each of the plurality of clusters. The each of the plurality of clusters may correspond to each of the plurality of robots 10_1 to 10_N.

In some embodiments, the redistribution determiner 26 may exclude outlier task points from among the task points allocated to each of the plurality of robots 10_1 to 10_N using a density-based spatial clustering of applications with noise (DBSMAY) algorithm, and may calculate the center point of each of the plurality of clusters using the task points allocated to each robot 10_1 to 10_N excluding the outlier task points have been excluded.

The DBSMAY algorithm is a density-based clustering algorithm, and the density-based cluster generation conditions of the DBSMAY algorithm may be set as follows.
1) A core point must have at least MinPts neighbors within a radius ε, as in Equation 1.

$$Core point : \vert \{ x \_ j ∈ X \vert d ( x \_ i , x \_ j ) \leq ε \} \vert \geq Min Pts \qquad ( Equation 1 )$$

Here, ε represents the maximum distance (radius) for a task point to be considered as part of a cluster, and Minpts represents the minimum number of neighbors for a task point to become the core point of a cluster. Also, d(xᵢ,xⱼ) represents the Euclidean distance, which is the distance between the task point xᵢ and the task point xⱼ.
2) A boundary point is a point within the radius ¿ of a core point, but cannot be a core point itself.
3) A noise point is a point that is neither a core point nor a boundary point.

The redistribution determiner 26 may perform density-based clustering on the allocated task points for each of the plurality of robots 10_1 to 10_N to generate at least one cluster, and detect a cluster that includes the most task points among the at least one cluster as a main cluster.

If the DBSMAY algorithm fails to detect appropriate main cluster in a particular data distribution, it may retry clustering by adjusting the parameters ε and MinPts. This is a method to better detect clusters with different densities, and parameter adjustment may be performed as in Equations 2 and 3.

$$ε = ε \times 1.1 \qquad ( Equation 2 )$$

$$Min Pts = max ( 2 , Min Pts - 1 ) \qquad ( Equation 3 )$$

That is, parameter ε is increased and parameter MinPts is decreased for each clustering iteration, making it easier to find main cluster.

The DBSMAY algorithm repeats clustering while adjusting the parameters ε and MinPts, and may repeat clustering as many times as the maximum number of attempts. When the number of clustering iterations reaches the maximum number of attempts, no more parameter adjustments are attempted and the results are returned.

That is, clustering may be performed by adjusting the parameters ε and MinPts within the maximum number of attempts until the main cluster is detected.

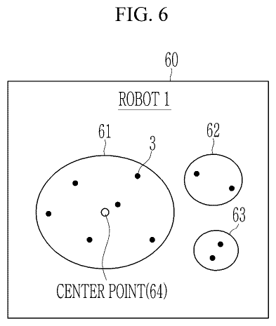

FIG. 6 is a diagram showing an example of a method for calculating a center point of a cluster according to an embodiment.

Referring to FIG. 6, a cluster 60 includes task points 3 allocated to robot 1.

The redistribution determiner 26 may perform density-based clustering of the task points 3 allocated to robot 1, and then generate at least one cluster 61, 62, and 63. In FIG. 6, it is assumed that three clusters 61, 62, and 63 were generated through density-based clustering when 10 task points 3 were allocated to robot 1.

During the clustering process, a specific cluster 61 may include more task points (i.e., data) than other clusters 62 and 63. Among the plurality of clusters 61, 62, and 63 for robot 1, the cluster 61 including the largest number of task points, as in Equation 4, may be set as the main cluster of robot 1.

$${C}_{main} = {arg max \vert}_{k} \{ {x}_{i} ∈ X \vert label ( {x}_{i} ) = k \} \vert \qquad ( Equation 4 )$$

In Equation 4, Cₘₐᵢₙ represents the main cluster, k represents the cluster label, and xᵢ is the task point.

The redistribution determiner 26 may calculate the center point 64 of the main cluster 61 of robot 1 and set the center point 64 of the main cluster 61 as a center point of the cluster 60 of robot 1. The center point of the main cluster 61 may be calculated using the average value of the task points included in the main cluster 61 as in Equation 5.

$${μ}_{main} = \frac{1}{\vert {C}_{main} \vert} {\sum }_{i ∈ {C}_{main}} {X}_{i} \qquad ( Equation 5 )$$

In Equation 5, μₘₐᵢₙ represents the center point of the main cluster. |Cₘₐᵢₙ| may represent the number of task points included in the main cluster.

In this way, the redistribution determiner 26 may detect a main cluster for each of the plurality of robots 10_1 to 10_N and set the center point of the main cluster for each of the plurality of robots 10_1 to 10_N as the center point of the cluster corresponding to each of the plurality of robots 10_1 to 10_N.

Again, referring to FIG. 5, the redistribution determiner 26 may calculate the Euclidean distance between each of the plurality of task points and the center point of each of the plurality of clusters (S530). The Euclidean distance between a task point and the center point of the cluster corresponding to a robot may be calculated as in Equation 6.

$$d ( {x}_{i} , {μ}_{main} ) = // {x}_{i} - {μ}_{main} {//}_{2} = \sqrt{{\sum }_{j = 1}^{d} {( {x}_{ij} - {μ}_{main , j} )}^{2}} \qquad ( Equation 5 )$$

Here, xᵢ is the i-th task point, μₘₐᵢₙ is the center point of the main cluster Cₘₐᵢₙ, and may be set as the center point of the cluster corresponding to a certain robot. d may represent the number of dimensions of the task point.

That is, the Euclidean distance between a task point and the center point of the cluster corresponding to a certain robot is obtained by squaring the differences between corresponding coordinates in each dimension, adding them all together, and taking the square root of the adding result.

FIG. 7 is a diagram showing an example of the Euclidean distance between a task point and a center point of each of a plurality of clusters according to an embodiment.

Referring to FIG. 7, the center point of the cluster 60 corresponding to robot 1, which includes all of the task points 3 allocated to robot 1, may be set as the center point 64 of the main cluster 61 through the method described with reference to FIG. 5.

The center point of the cluster 70 corresponding to robot 2, which includes all of the task points 3 allocated to robot 2, may be set as the center point 72 of the main cluster 71 using the method described with reference to FIG. 5.

The center point of the cluster 73 corresponding to robot 3, which includes all of the task points 3 distributed to robot 3, may be set as the center point 75 of the main cluster 74 using the method described with reference to FIG. 5.

In FIG. 7, three robots are assumed for convenience of explanation.

The redistribution determiner 26 calculates the Euclidean distance between each of the plurality of task points 3 allocated to robot 1, robot 2, and robot 3 and each of the center point 64, 72, and 75 of the cluster 60, 70, and 73 corresponding to each of robot 1, robot 2, and robot 3.

For example, among the plurality of task points 3, if the description will be based on task point A included in the cluster 60 of robot 1, the redistribution determiner 26 may calculate the Euclidean distance d1 between the task point A and the center point 64 of the cluster of robot 1, calculate the Euclidean distance d2 between the task point A and the center point 72 of the cluster of robot 2, and calculate the Euclidean distance d3 between the task point A and the center point 75 of the cluster of robot 3.

In this way, the redistribution determiner 26 may calculate the Euclidean distance between each of the plurality of task points 3 in the task space and each of the center point 64, 72, and 75 of each of the clusters 60, 70, and 73 of robot 1, robot 2, and robot 3.

Again, referring to FIG. 5, the redistribution determiner 26 checks check whether there is a Euclidean distance shorter than the Euclidean distance to the center point of the cluster in which each task point is included (S540), using the Euclidean distances calculated for each of the plurality of task points to the center point of each of the plurality of clusters.

The redistribution determiner 26 determines that, if there is a Euclidean distance shorter than the Euclidean distance to the center point of the cluster in which a certain task point is included among the plurality of Euclidean distances calculated for a task point, the task point as a redistribution-required task point. That is, the redistribution-required task point may be a task point that is closer to the center point of the cluster corresponding to another robot than the center point of the cluster corresponding to the robot to which the task point is currently allocated.

If there is a task point determined to be the redistribution-required task point (S550), the redistribution determiner 26 may determine a robot in a cluster that has a shorter Euclidean distance than the Euclidean distance to the center point of the cluster in which the task point is included among the plurality of Euclidean distances calculated for the task point as a redistribution expected robot of the redistribution-required task point (S560).

In some embodiments, if there are two or more Euclidean distances shorter than the Euclidean distance to center point of the cluster in which the task point is included among the plurality of Euclidean distances calculated for the task point, the redistribution determiner 26 may determine the robot of the cluster with the shortest Euclidean distance among them as the redistribution expected robot of the redistribution-required task point.

For example, in FIG. 7, assuming that the Euclidean distance d2 between the task point A and the center point 72 of the cluster 70 is shorter than the Euclidean distance d1 between the task point A and the center point 64 of the cluster 60 in which the task point A is included, and the Euclidean distance d3 between the task point A and the center point 75 of the cluster 73 is longer than the Euclidean distance d1, the task point A distributed to robot 1 may be determined as a redistribution-required task point of robot 1, and at this time, the redistribution expected robot of the task point A determined as the redistribution-required task point may be determined as robot 2.

In this way, the redistribution determiner 26 may determine redistribution-required task points among the plurality of task points in the task space and redistribution expected robots for each of redistribution-required task points.

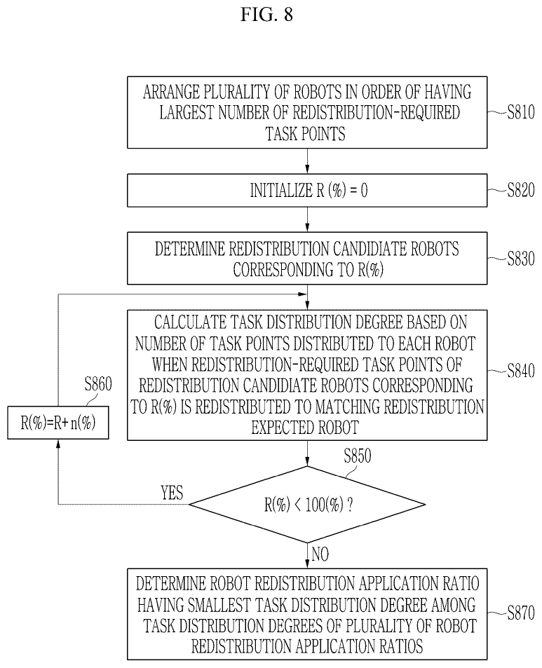

FIG. 8 is a flowchart illustrating a method for determining a robot re-distribution application ratio according to an embodiment.

Referring to FIG. 8, the redistribution determiner 26 may arrange the plurality of robots 10_1 to 10_N in order of having largest number of redistribution-required task points (S810).

The redistribution determiner 26 may initialize the robot redistribution application ratio R % to 0 (S820).

The redistribution determiner 26 determines redistribution candidate robots corresponding to the robot redistribution application ratio (R %) among the aligned plurality of robots 10_1 to 10_N (S830), and may calculate task distribution degree based on the number of task points distributed to each of the plurality of robots when each of the redistribution-required task points of the redistribution candidate robots corresponding to the robot redistribution application ratio (R %) is redistributed to the matching redistribution expected robot (S840).

If the robot redistribution application ratio (R %) is less than 100% (S840), the redistribution determiner 26 may increase the robot redistribution application ratio R % by n % (S850) and perform steps (S830 to S850). In this case, n may be a positive number.

The redistribution determiner 26 may calculate a task distribution degree at each robot redistribution application ratio while increasing the robot redistribution application ratio R % until the robot redistribution application ratio R % becomes 100%.

The redistribution determiner 26 may determine the robot redistribution application ratio having the smallest task distribution among the task distribution degrees calculated for a plurality of robot redistribution application ratios having an interval of n % from 0% to 100% (S870).

Meanwhile, a certain task points may not be redistributable by the redistribution expected redistribution robot. Before calculating the task distribution degree at each robot redistribution application ratio (R %), the redistribution determiner 26 may check task points that cannot be redistributed among the redistribution-required task points of the redistribution candidate robots belonging to the robot redistribution application ratio (R %) among the arranged the plurality of robots 10_1 to 10_N, and exclude task points that cannot be redistributed from the redistribution.

For example, it is assumed that there are 100 robots in the task space, numbered from Robot 1 to Robot 100, and that the number of redistribution-required task points is greater in the order of Robot 1, Robot 2, and Robot 3. At this time, when n=1, the task distribution degree may be calculated for the plurality of robot redistribution application ratios set at intervals of 1% from 1% to 100%.

First, for a robot redistribution application ratio of 1%, robot 1, which is the 1% robot with the largest number of redistribution-required task points among 100 robots, is determined as a redistribution candidate robot, and each of redistribution-required task points of robot 1 is redistributed to the matching redistribution expected robot, and then the task distribution degree for the robot redistribution application ratio of 1% may be calculated.

The redistribution-required task points of Robot 1 may be redistributed from Robot 2 to Robot 100 among the 100 robots, excluding Robot 1. At this time, it is assumed that the redistribution-required task points of robot 1 and the redistribution expected robots matching the redistribution-required task points are set as shown in Table 1. According to Table 1, the redistribution-required task points of robot 1 may be redistributed to the redistribution expected robots, and the task distribution degree at a robot redistribution application ratio of 1% may be calculated based on the number of task points distributed to robot 1 to robot 100.

TABLE 1

| Redistribution-requiring | Redistribution |
|---|---|
| task point of robot 1 | candidate robot |
| Task point A | Robot 2 |
| Task point B | Robot 3 |
| Task point C | Robot 4 |
| Task point D | Robot 2 |
| Task point E | Robot 3 |
| Task point F | Robot 4 |

Next, for a robot reallocation application ratio of 2%, robots 1 and 2, which are the 2% robots with the largest number of redistribution-required task points, are determined as redistribution candidate robots, and the redistribution-required task points of robots 1 and 2 may be redistributed to the redistribution expected robots.

At this time, it is assumed that the redistribution-required task points of robot 2 and the redistribution expected robots matching the redistribution-required task points are set as shown in Table 2.

TABLE 2

| Redistribution-requiring | Redistribution |
|---|---|
| task point of robot 2 | candidate robot |
| Task point G | Robot 1 |
| Task point H | Robot 3 |
| Task point I | Robot 4 |
| Task point J | Robot 3 |
| Task point K | Robot 5 |

The redistribution-required task points of robot 1 and robot 2 may be redistributed from robot 3 to robot 100, excluding robot 1 and robot 2, among the 100 robots.

When the redistribution-required task points of robot 1 and the redistribution expected robots of robot 1 are determined as shown in Table 1, and the redistribution-required task points of robot 2 and the redistribution expected robots of robot 2 are determined as shown in Table 2, among the redistribution-required task points of robot 1, the redistribution expected robots for task points A and D are robot 2, and since robot 2 is a redistribution candidate robot to perform redistribution, the robot 2 cannot be distributed task points A and D. Therefore, task points A and D cannot be redistributed to the redistribution expected robot. Also, among the redistribution-required task points of robot 2, the redistribution expected robot for task point G is robot 1, and robot 1 is also a redistribution candidate robot that will perform redistribution, so robot 1 cannot be distributed task point G. Therefore, the task point G cannot be redistributed to the redistribution expected robot.

In this way, among the redistribution-required task points of robots 1 and 2, each of the remaining task points, excluding the task points that cannot be redistributed, may be redistributed to the matched redistribution expected robot, and the task distribution degree at a robot redistribution application ratio of 2% may be calculated based on the number of task points distributed from robots 1 to 100.

In this way, the redistribution determiner 26 determines task points that cannot be redistributed from among the redistribution-required task points of the redistribution candidate robots, according to each robot redistribution application ratio, and when each of the remaining redistribution-required task points, excluding the task points that cannot be redistributed, is redistributed to the matching redistribution expected robot, and then the task distribution degree at each robot redistribution application ratio may be calculated based on the number of task points distributed to each robot.

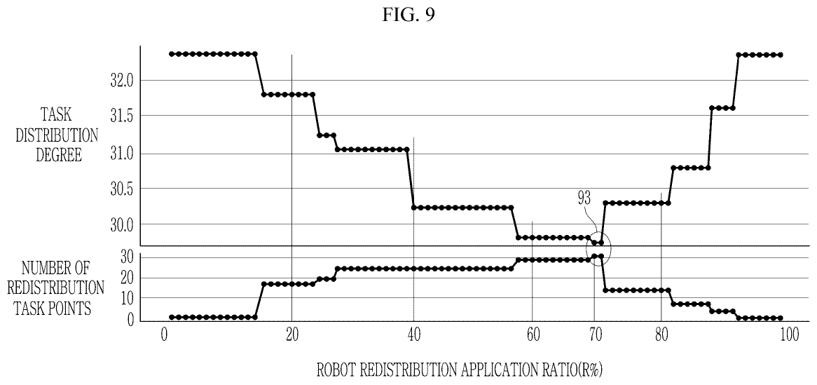

FIG. 9 is a diagram showing a task distribution degree according to the robot redistribution application ratio according to an embodiment.

Referring to FIG. 9, when n=1, in each of the plurality of robot redistribution application ratios set at intervals of 1% from 1% to 100%, when each of the remaining redistribution-required task points, excluding the task points that cannot be redistributed, among the redistribution-required task points, is redistributed to the matching redistribution expected robot, and then the task distribution degree at each robot redistribution application ratio may be calculated based on the number of task points distributed to each robot.

The redistribution determiner 26 may select one of the robot redistribution application ratios 93 having the smallest task distribution among the task distribution degrees calculated from the plurality of robot redistribution application ratios R %.

In some embodiments, the redistribution determiner 26 may select the smallest robot redistribution application ratio 93 among two or more redistribution application ratios having the smallest task distribution. For example, as shown in FIG. 9, when the robot redistribution application ratios having the smallest task distribution degree are 70% and 71%, the redistribution determiner 26 may select the robot redistribution application ratio of 70%.

The redistribution determiner 26 may redistribute each of the remaining redistribution-required task points excluding task points that cannot be redistributed, among redistribution-required task points of the redistribution candidate robots corresponding to the selected robot redistribution application ratio (R %) to the matched redistribution expected robots.

In the case of FIG. 9, when the redistribution determiner 26 arranges the plurality of robots 10_1 to 10_N in order of having the largest number of redistribution-required task points, it may redistribute each of the 30 redistribution-required task points of the redistribution candidate robots belonging to a robot redistribution application ratio of 70% among all robots 10_1 to 10_N to the matched redistribution expected robot.

In this way, the reallocation determiner 26 may minimize the difference in task completion time between the plurality of robots 10_1 to 10_N by selecting the robot reallocation application ratio (R %) with the smallest task distribution degree among a plurality of robot reallocation application ratios (R %), thereby reducing the total task time.

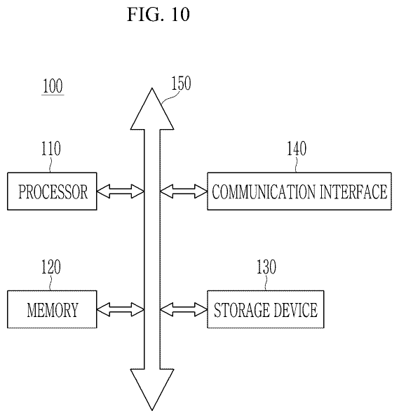

FIG. 10 is a drawing showing a multi-robot control apparatus according to another embodiment.

Referring to FIG. 10, the multi-robot control apparatus 100 may represent a computing device in which the task allocation method described above is implemented.

The multi-robot control apparatus 100 includes a processor 110, a memory 120, a storage device 130, a communication interface 140, and a bus 150. The multi-robot control apparatus 100 may further include other general-purpose components of a computing device.

The processor 110 may control the overall operation of each component of the multi-robot control apparatus 100. The processor 110 may be implemented as at least one of various processing units such as a microprocessor, a central processing unit (CPU), a graphic processing unit (GPU), a microprocessor unit (MPU), and a micro controller unit (MCU), and may also be implemented as a parallel processing unit. In addition, the processor 110 may perform operations for a program for executing the task allocation method described above.

In some embodiments, the processor 110 may store in memory 120 a computer program for implementing at least some functions of the multi-robot control apparatus 20 illustrated in FIG. 2.

The memory 120 may store various data, instructions and/or information.

The memory 120 may load the computer program from the storage device 130 to execute the multi-robot control method and/or the task reallocation method described above. The storage device 130 may store programs non-temporarily. The storage device 130 may be implemented as non-volatile memory.

The communication interface 140 may support wired and wireless Internet communication of the multi-robot control apparatus 100. In addition, the communication interface 140 may support various communication methods other than Internet communication.

The bus 150 may provide communication functions between components of the multi-robot control apparatus 100. The bus 150 may be implemented as various types of buses such as an address bus, a data bus, and a control bus.

The computer program may include instructions causing the processor 110 to perform a task allocation method when loaded into the memory 120. That is, the processor 110 may perform operations for a task allocation method by executing instructions.

In some embodiments, the task allocation method may be implemented as a computer program on a computer-readable storage medium. In some embodiments, the computer-readable recording medium may be a removable recording medium or a fixed recording medium. In some embodiments, a computer program recorded on a computer-readable recording medium may be transmitted to another computing device through a network such as the Internet and installed and executed on the other computing device.

According to at least one embodiment, when tasks are allocated to a plurality of robots in a task space, by appropriately reallocating tasks that are excessively allocated to a specific robot, the difference in task completion times between robots may be minimized, thereby reducing the total task time.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A method for allocating a plurality of tasks to a plurality of robots, the method comprising:
allocating, by a processor, corresponding task points among a plurality of task points to each of the plurality of robots;
determining, by the processor, redistribution-required task points that need to be redistributed for each of the plurality of robots based on a number of task points allocated to each of the plurality of robots;
matching, by the processor, a corresponding redistribution expected robot to each of the redistribution-required task points of each of the plurality of robots;
arranging, by the processor, the plurality of robots in order of the number of task points requiring redistribution of each of the plurality of robots;
determining, by the processor, redistribution candidate robots belonging to each robot redistribution application ratio among the arranged plurality of robots, according to each of a plurality of robot redistribution application ratios indicating a ratio at which a redistribution is performed among the plurality of robots;
redistributing, by the processor, a plurality of redistribution-required task points of the redistribution candidate robots to a plurality of redistribution expected robots matched to the plurality of redistribution-required task points, for each of the plurality of robot redistribution application ratios;
calculating, by the processor, a task distribution degree based on the number of task points of each of the plurality of robots, for each of the plurality of robot redistribution application ratios;
determining, by the processor, a first robot redistribution application ratio having a smallest task distribution degree among the task distribution degrees calculated for the plurality of robot redistribution application ratios;
redistributing each of the plurality of redistribution-required task points of first redistribution candidate robots corresponding to the first robot redistribution application ratio to the matched redistribution expected robot; and
controlling the plurality of robots according to the task points finally distributed to each of the plurality of robots.

2. The method of claim 1, wherein determining the redistribution-required task points comprises:
calculating a center point of each of a plurality of clusters including task points distributed to each of the plurality of robots and corresponding to each of the plurality of robots;
calculating Euclidean distance between each of the plurality of task points and the center point of each of the plurality of clusters; and
determining the redistribution-required task points among the plurality of task points by using the Euclidean distances calculated for each of the plurality of task points to the center point of each of the plurality of clusters.

3. The method of claim 2, wherein determining the redistribution-required task points among the plurality of task points comprises:
comparing a plurality of first Euclidean distances and a second Euclidean distance, for each of the plurality of task points, wherein the plurality of first Euclidean distances which are Euclidean distances between each task point and the center point of each of a plurality of first cluster that do not include the each task point among the plurality of clusters, the second Euclidean distance which is a Euclidean distance between each task point and the center point of a second cluster that includes each task point; and
determining a task point having at least one first Euclidean distance shorter than the second Euclidean distance among the plurality of task points as the redistribution-required task point.

4. The method of claim 2, wherein matching comprises determining a robot of a cluster corresponding to the shortest Euclidean distance among the Euclidean distances between each redistribution-required task point and the center points of the plurality of first clusters that do not include the each redistribution-required task point among the plurality of clusters, as the redistribution expected robot for the each redistribution-required task.

5. The method of claim 2, wherein calculating the center point of each of a plurality of clusters comprises:
generating at least one first cluster by performing density-based clustering on the task points allocated to each robot; and
setting the center point of a first cluster including the largest number of task points among the at least one first cluster for each robot as the center point of the cluster corresponding to each robot.

6. The method of claim 1, wherein calculating the task distribution degree comprises excluding task points that cannot be redistributed among the plurality of redistribution-required task points of the redistribution candidate robots, from redistribution.

7. The method of claim 6, wherein excluding comprises determining redistribution-required task points corresponding to the redistribution candidate robot among the plurality of redistribution-required task points of the redistribution candidate robots as the task points that cannot be redistributed.

8. The method of claim 1, wherein determining redistribution-required task points comprises determining the redistribution-required task points for each of the plurality of robots, based at least in part on a difference between the number of least allocated task points and the number of most allocated task points among task points allocated to each of the plurality of robots being greater than a set threshold value.

9. A multi-robot control apparatus for allocating a plurality of task points in a task space to a plurality of robots, the multi-robot control apparatus comprising:
a memory configured to store one or more instructions; and
a processor configured to execute the one or more instructions,
wherein the one or more instructions include instructions for:
allocating corresponding task points among the plurality of task points to each of the plurality of robots;
determining redistribution-required task points that need to be redistributed for each of the plurality of robots by using Euclidean distance between each of the plurality of task points and a center point of each of a plurality of clusters including the task points allocated to each of the plurality of robots;
matching a corresponding redistribution expected robot to each of redistribution-required task points of each of the plurality of robots;
redistributing at least one of the redistribution-required task points of each of the plurality of robots to the corresponding redistribution expected robot; and
controlling the plurality of robots according to the task points finally distributed to each of the plurality of robots.

10. The multi-robot control apparatus of claim 9, wherein the one or more instructions further include instructions for:
arranging the plurality of robots in order of a number of task points requiring redistribution of each of the plurality of robots; and
determining redistribution candidate robots belonging to each robot redistribution application ratio among the arranged plurality of robots, according to each of a plurality of robot redistribution application ratios indicating a ratio at which redistribution is performed among the plurality of robots, redistributes a plurality of redistribution-required task points of the redistribution candidate robots to a plurality of redistribution expected robots matched to the plurality of redistribution-required task points among the plurality of robots, in each of the plurality of robot redistribution application ratios, calculates a task distribution degree based on the number of task points of each of the plurality of robots, in each of the plurality of robot redistribution application ratios, and redistributes each of the plurality of redistribution-required task points of first redistribution candidate robots corresponding to a first robot redistribution application ratio having the smallest task distribution degree among the task distribution degrees calculated for the plurality of robot redistribution application ratios, to the matched redistribution expected robot.

11. The multi-robot control apparatus of claim 10, wherein the one or more instructions further include instructions for determining redistribution-required task points corresponding to the redistribution candidate robots among the plurality of redistribution-required task points of the redistribution candidate robots as task points that cannot be redistributed, and excludes task points that cannot be redistributed among the plurality of redistribution-required task points of the redistribution candidate robots, from redistribution.

12. The multi-robot control apparatus of claim 10, wherein the one or more instructions further include instructions for setting the plurality of robot redistribution application ratios from top 0% to 100% at a predetermined interval.

13. The multi-robot control apparatus of claim 9, wherein the one or more instructions further include instructions for comparing a plurality of first Euclidean distances and a second Euclidean distance, for each of the plurality of task points, wherein the plurality of first Euclidean distances which are Euclidean distances between each task point and the center point of each of a plurality of first cluster that do not include the each task point among the plurality of clusters, the second Euclidean distance which is a Euclidean distance between the each task point and the center point of a second cluster that includes the each task point, and determines a task point having at least one first Euclidean distance shorter than the second Euclidean distance among the plurality of task points as the redistribution-required task point.

14. The multi-robot control apparatus of claim 13, wherein the one or more instructions further include instructions for determining a robot of a cluster corresponding to the shortest first Euclidean distance among the at least one first Euclidean distance as the redistribution expected robot for the redistribution-required task.

15. The multi-robot control apparatus of claim 9, wherein the one or more instructions further include instructions for generating at least one first cluster by performing density-based clustering on the task points allocated to each robot, and sets the center point of a first cluster including the largest number of task points among the at least one first cluster for each robot as the center point of the cluster corresponding to each robot.

16. The multi-robot control apparatus of claim 9, wherein the one or more instructions further include instructions for determining the redistribution-required task points for each of the plurality of robots, if the difference between the number of least allocated task points and the number of most allocated task points among task points allocated to each of the plurality of robots is greater than a set threshold value.

17. A non-transitory computer-accessible media storing instructions that, when accessed by a processor, cause the processor to perform:
allocating corresponding task points among a plurality of task points to each of a plurality of robots;
determining redistribution-required task points to be redistributed for each of the plurality of robots;
matching redistribution expected robots to the redistribution-required task points;
determining a plurality of robot redistribution application ratios indicating a ratio at which redistribution is performed among the plurality of robots;
calculating a task distribution degree for each robot redistribution application ratios;
determining a first robot redistribution application ratio having the smallest task distribution degree;
redistributing the redistribution-required task points based at least in part on the first robot redistribution application ratio; and
controlling the plurality of robots according to the task points finally distributed to each of the plurality of robots.

18. The media of claim 17, the instructions including further instructions to perform:
determining redistribution-required task points based at least in part on the number of task points allocated to each of the plurality of robots;
matching redistribution expected robots based at least in part on matching each of redistribution-required task points of each of the plurality of robots among the plurality of robots; and
arranging the plurality of robots in order of number of task points requiring redistribution of each of the plurality of robots.

19. The medium of claim 17, wherein the instructions for determining redistribution-required task points includes further instructions to cause the processor to perform:
calculating a center point of each of a plurality of clusters including task points distributed to each of the plurality of robots and corresponding to each of the plurality of robots;
calculating Euclidean distance between each of the plurality of task points and the center point of each of the plurality of clusters; and
determining the redistribution-required task points based at least in part on the calculated Euclidean distances.

20. The medium of claim 17, wherein the instructions for determining the redistribution-required task points includes further instructions to cause the processor to perform:
calculating a center point of a second cluster that includes each task point each of a plurality of clusters including task points distributed to each of the plurality of robots;
comparing a plurality of first distances and a second distance, for each of the plurality of task points, wherein the plurality of first distances correspond to Euclidean distances between each task point and the center point of each of a plurality of first clusters, and the second distance corresponds to a Euclidean distance between each task point and the center point of a second cluster that includes each task point; and
determining a task point having at least one first distance shorter than the second distance among the plurality of task points as the redistribution-required task point.
